(19) United States
(12) Patent Application Publication
(10) Pub. No.: US 2023/0183906 A1
(43) Pub. Date: Jun. 15, 2023

(54) CLOTHING TREATMENT SYSTEM AND CLOTHING TREATMENT DEVICE

(71) Applicant: SAMSUNG ELECTRONICS CO., LTD., Suwon-si (KR)

(72) Inventors: Jeongnam KIM, Suwon-si (KR); Jooyoo KIM, Suwon-si (KR); Heekyung YANG, Suwon-si (KR); Jeongchoul PARK, Suwon-si (KR); Jongwoon PARK, Suwon-si (KR); Jieun LEE, Suwon-si (KR); Jihyouk CHOI, Suwon-si (KR)

(73) Assignee: SAMSUNG ELECTRONICS CO., LTD., Suwon-si (KR)

(21) Appl. No.: 18/107,248

(22) Filed: Feb. 8, 2023

Related U.S. Application Data
(63) Continuation of application No. PCT/KR2021/007847, filed on Jun. 23, 2021.

(30) Foreign Application Priority Data
Aug. 18, 2020 (KR) 10-2020-0103446

(51) Int. Cl. D06F 34/05; G06V 40/16; G06V 20/60; H04N 7/18; D06F 95/00; D06F 34/32

(52) U.S. Cl. CPC D06F 34/05; G06V 40/172; G06V 20/60; H04N 7/183; D06F 95/00; D06F 34/32; H04N 7/188; D06F 2105/58

(57) ABSTRACT

A clothing treatment device including a communicator configured to receive at least one of laundry information, dry information, and location information of clothes owned by a plurality of users from a server; a camera; a display; and a controller configured to update status information of the clothes owned by the plurality of users based on at least one of the laundry information, dry information, and location information of the clothes owned by the plurality of users, control the display to provide a first user interface for providing status information of clothes owned by a first user in response to an object captured by the camera determined as the first user, and control the display to provide a second user interface for providing status information of clothes owned by a second user in response to an object captured by the camera determined as the second user.

### CROSS-REFERENCE TO RELATED APPLICATIONS

This application is a continuation of International Application PCT/KR2021/007847, filed Jun. 23, 2021, and claims foreign priority to Korean application 10-2020-0103446, filed Aug. 18, 2020, the disclosures of which are incorporated herein by reference in their entireties.

### BACKGROUND

### 1. Field

The disclosure relates to a clothing treatment system and clothing treatment device, and more particularly, to a clothing treatment device serving as a hub for clothing care and a clothing treatment system using the clothing treatment device.

### 2. Description of Related Art

A clothing treatment device is a device for performing clothing care such as drying wet clothes, removing dust or odors from clothes, reducing wrinkles of clothes, etc.

In general, the clothing treatment device includes a cabinet forming a clothing care room for receiving clothes and a door provided to open and close the cabinet.

The clothing treatment device may include a hot air supplier for supplying hot air into the clothing care room to dry the clothes, and a steam generator for performing a refresh function such as removing wrinkles, deodorizing, removing static electricity from the clothes.

The clothing treatment device may include a relatively large display unlike other home appliances, so is able to send various information to the user.

### SUMMARY

According to an aspect of the disclosure, a clothing treatment system includes a clothing treatment device configured to store status information of clothes owned by a plurality of users including a first user and a second user; a washing machine configured to send laundry information of the clothes owned by the plurality of users to a server; and a dryer configured to send dry information of the clothes owned by the plurality of users to the server. The clothing treatment device is configured to receive, from the server, the laundry information sent by the washing machine to the server and the dry information sent by the dryer to the server, update status information of the clothes owned by the plurality of users based on the laundry information and dry information received from the server, provide a first user interface for providing status information of clothes owned by the first user through a display in response to an object captured by a camera determined as the first user, and provide a second user interface for providing status information of clothes owned by the second user through the display in response to an object captured by the camera determined as the second user.

The clothing treatment device may request laundry information of the clothes owned by the first user from the server and request dry information of the clothes owned by the first user from the server in response to an object captured by the camera determined as the first user.

The clothing treatment device may create recommended coordinates information for the first user based on status information of the clothes owned by the first user and provide the recommended coordinates information for the first user through the display in response to an object captured by the camera determined as the first user.

The clothing treatment device may recognize clothing worn by an object captured by the camera and update at least one of information about a date of wearing and information about a number of wearing times of the recognized clothing.

The clothing treatment device may determine clothing requiring washing among the clothes owned by the plurality of users based on at least one of laundry information, dry information, information about the number of wearing times, and wearing date information of the clothes owned by the plurality of users, and provide information about the clothing requiring washing among clothes owned by the first user through the display in response to an object captured by the camera determined as the first user.

The clothing treatment device may send information about clothes requiring washing among the clothes owned by the first user to at least one of the washing machine and the dryer through the server.

The clothing treatment device may update location information of the clothes owned by the plurality of users based on at least one of laundry information of the clothes owned by the plurality of users and dry information of the clothes owned by the plurality of users.

The washing machine may send maintenance information of the washing machine to the clothing treatment device through the server, and the clothing treatment device may provide the maintenance information of the washing machine to the first user through the display in response to an object captured by the camera determined as the first user and a maintenance type of the washing machine corresponding to a first type, and provide the maintenance information of the washing machine to the second user through the display in response to an object captured by the camera determined as the second user and a maintenance type of the washing machine corresponding to a second type.

The dryer may send maintenance information of the dryer to the clothing treatment device through the server, and the clothing treatment device may provide the maintenance information of the dryer to the first user through the display in response to an object captured by the camera determined as the first user and a maintenance type of the dryer corresponding to a first type, and provide the maintenance information of the dryer to the second user through the display in response to an object captured by the camera determined as the second user and a maintenance type of the dryer corresponding to a second type.

According to an aspect of the disclosure, a clothing treatment device includes a storage configured to store status information of clothes owned by a plurality of users including a first user and a second user; a communicator configured to receive at least one of laundry information, dry information, and location information of the clothes owned by the plurality of users from a server; a camera; a display; and a controller configured to update the status information of the clothes owned by the plurality of users based on at least one of the laundry information, dry information or location information of the clothes owned by the plurality of users, control the display to provide a first user interface for providing status information of clothes owned by the first user in response to an object captured by the camera determined as the first user, and control the display to provide a second user interface for providing status information of clothes owned by the second user in response to an object captured by the camera determined as the second user.

The controller may control the communicator to request at least one of laundry information, dry information, and location information of the clothes owned by the first user from the server in response to an object captured by the camera determined as the first user.

The controller may create recommended coordinates information for the first user based on the status information of the clothes owned by the first user in response to an object captured by the camera determined as the first user, and control the display to provide the recommended coordinates information for the first user.

The controller may recognize clothing worn by an object captured by the camera and update at least one of information about a date of wearing and information about a number of wearing times of the recognized clothing.

The controller may determine clothing requiring washing among the clothes owned by the plurality of users based on at least one of laundry information, dry information, information about the number of wearing times, and wearing date information of the clothes owned by the plurality of users, and control the display to provide information about the clothing requiring washing among clothes owned by the first user in response to an object captured by the camera determined as the first user.

The controller may determine clothing requiring washing among the clothes owned by the plurality of users based on at least one of laundry information, dry information, information about the number of wearing times, and wearing date information of the clothes owned by the plurality of users, and control the display to provide information about the clothing requiring washing among the clothes owned by the plurality of users in response to an object captured by the camera determined as the first user.

The controller may control the communicator to send information about clothes requiring washing among the clothes owned by the plurality of users to at least one of a washing machine and a dryer through the server.

The controller may update location information of the clothes owned by the plurality of users based on at least one of laundry information of the clothes owned by the plurality of users and dry information of the clothes owned by the plurality of users.

The communicator may receive maintenance information of a home appliance from the server, and the controller may control the display to provide the maintenance information of the home appliance to the first user in response to an object captured by the camera determined as the first user and a maintenance type of the home appliance corresponding to a first type, and control the display to provide the maintenance information of the home appliance to the second user in response to an object captured by the camera determined as the second user and the maintenance type of the home appliance corresponding to a second type.

The controller may control the communicator to request the first type of maintenance information from the home appliance through the server in response to an object captured by the camera determined as the first user, and control the communicator to request the second type of maintenance information from the home appliance through the server in response to an object captured by the camera determined as the second user.

The controller may control the communicator to request maintenance information from the washing machine through the server in response to an object captured by the camera determined as the first user, and control the communicator to request maintenance information from the dryer through the server in response to an object captured by the camera determined as the second user.

Additional aspects will be set forth in part in the description which follows and, in part, will be apparent from the description, or may be learned by practice of the presented embodiments.

### DESCRIPTION OF THE DRAWINGS

Aspects, features, and advantages of certain embodiments of the present disclosure will be more apparent from the following description taken in conjunction with the accompanying drawings, in which:

FIG. 1 illustrates a clothing treatment system, according to an embodiment of the disclosure.

FIG. 2 is a control block diagram of a clothing treatment system, according to an embodiment of the disclosure.

FIG. 3 is a perspective view illustrating a clothing treatment device, according to an embodiment of the disclosure.

FIG. 4 is a cross-sectional view illustrates a clothing treatment device, according to an embodiment of the disclosure.

FIG. 5 is an exploded perspective view of a clothing treatment device, according to an embodiment of the disclosure.

FIGS. 6A and 6B are a flowchart illustrating operations of a clothing treatment system, according to an embodiment of the disclosure.

FIGS. 7 and 8 are diagrams for describing individualized clothing information provided for a first user, according to an embodiment of the disclosure.

FIGS. 9 and 10 illustrate examples of individualized clothing information provided for a second user, according to an embodiment of the disclosure.

FIG. 11 is a flowchart illustrating a procedure in which a clothing treatment device determines clothes requiring care, according to an embodiment of the disclosure.

FIG. 12 illustrates an example of information about clothes requiring care provided for a first user and a second user, according to an embodiment of the disclosure.

FIG. 13 is a sequence chart illustrating a procedure in which a clothing treatment system provides individualized maintenance information, according to an embodiment of the disclosure.

FIG. 14 illustrates an example of maintenance information of a home appliance provided for a first user and a second user, according to an embodiment of the disclosure.

FIG. 15 illustrates another example of maintenance information of a home appliance provided for a first user and a second user, according to an embodiment of the disclosure.

### DETAILED DESCRIPTION

Embodiments and features as described and illustrated in the disclosure are merely examples, and there may be various modifications replacing the embodiments and drawings at the time of filing this application.

The terminology used herein is for the purpose of describing particular embodiments only and is not intended to limit the disclosure.

For example, the singular forms “a”, “an” and “the” as herein used are intended to include the plural forms as well, unless the context clearly indicates otherwise.

The terms “comprises” and/or “comprising,” when used in this specification, represent the presence of stated features, integers, steps, operations, elements, components or combinations thereof, but do not preclude the presence or addition of one or more other features, integers, steps, operations, elements, components, or combinations thereof.

The term including an ordinal number such as “first”, “second”, or the like is used to distinguish one component from another and does not restrict the former component.

Furthermore, the terms, such as “˜part”, “˜block”, “˜member”, “˜module”, etc., may refer to a unit of handling at least one function or operation. For example, the terms may refer to at least one process handled by hardware such as a field-programmable gate array (FPGA)/application specific integrated circuit (ASIC), etc., software stored in a memory, or at least one processor.

Terms such as “at least one of A and B”, as used herein, includes any of the following: A, B, A and B.

Terms such as “at least one of A, B, and C”, as used herein, includes any of the following: A, B, C, A and B, A and C, B and C, A and B and C.

According to various embodiments of the disclosure, a clothing treatment system and clothing treatment device are capable of collecting information about clothes owned by users at home and of providing individualized information for each user.

According to various embodiments of the disclosure, information about clothes owned by a user may be provided to the user, thereby facilitating clothing care.

Furthermore, according to various embodiments of the disclosure, individualized information may be provided for the user, thereby maximizing satisfaction of the individual user.

An embodiment of the disclosure will now be described in detail with reference to accompanying drawings. Throughout the drawings, like reference numerals or symbols refer to like parts or components.

The working principle and embodiments of the disclosure will now be described with reference to accompanying drawings.

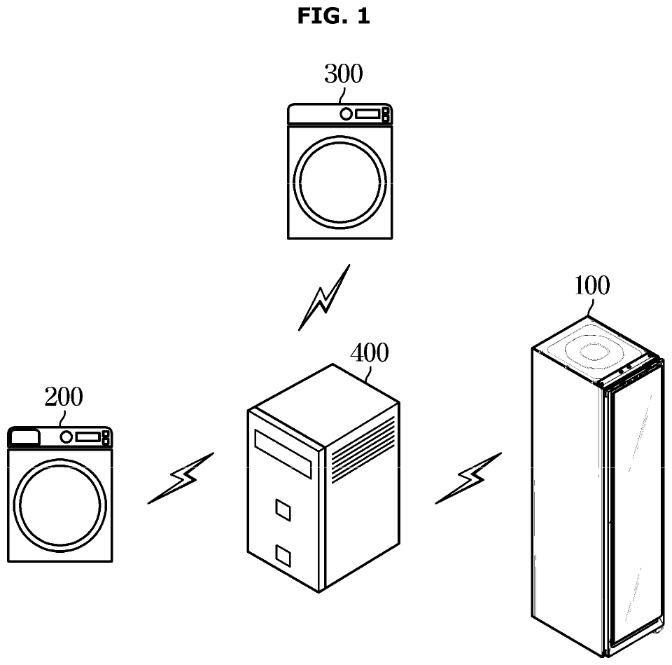

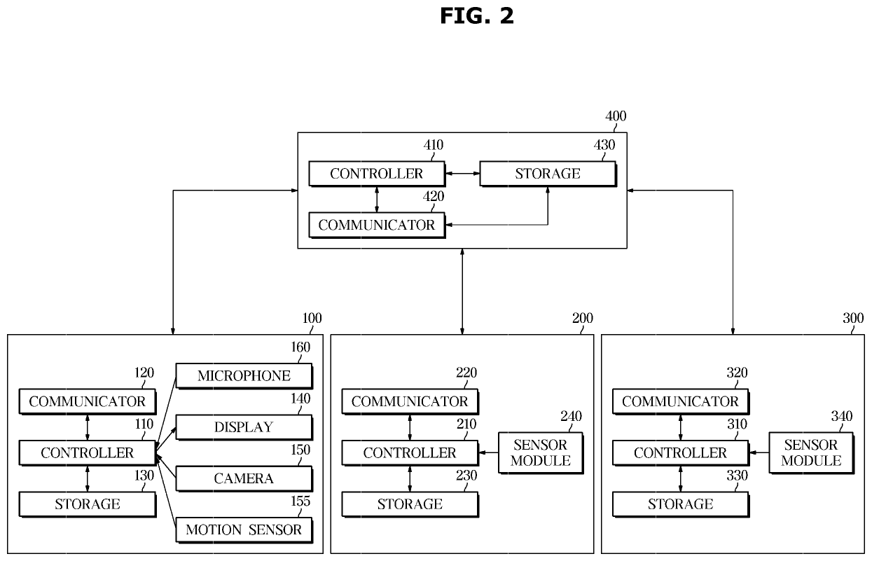

FIG. 1 illustrates a clothing treatment system, according to an embodiment, and FIG. 2 is a control block diagram of a clothing treatment system, according to an embodiment.

Referring to FIG. 1, a clothing treatment system according to an embodiment may include home appliances such as a clothing treatment device 100, a washing machine 200 and a dryer 300, and a server 400 capable of communicating with the home appliances 100, 200 and 300.

In an embodiment, the server 400 may collect information relating to clothes from the clothing treatment device 100 and/or the washing machine 200 and/or the dryer 300, and send the collected clothing information to the clothing treatment device 100.

To explain a procedure for collecting the clothing information, assume that a near field communication (NFC) tag and/or a radio frequency identification (RFID) tag including information about a name, an image, a material, etc., is attached to the clothes of the user.

The user may send the clothing information to the server 400 by bringing a user equipment with an NFC chip and/or an RFID chip embedded therein into contact with the NFC tag and/or RFID tag of the clothes.

In a case that an NFC tag and/or an RFID tag having no clothing information is attached to clothes of the user, the user may create the clothing information in person by bringing the user equipment equipped with an NFC chip and/or an RFID chip into contact with the NFC tag and/or RFID tag of the clothes.

For example, the user equipment may provide a user interface for inputting clothing information when coming into contact with the NFC tag and/or RFID tag of the clothing, and the user may create clothing information by inputting various information such as an image of the clothing, a name of the clothing, a material of the clothing, a washing method, a drying method, etc., to the user equipment. The clothing information created as described above may be sent to the server 400 through the user equipment.

In this case, every user may be assigned an account for accessing the server 400, and when the user accesses the assigned account with the user equipment and send clothing information to the server 400, the server 400 may store the clothing information for the assigned account.

For example, when a first user U1 brings his/her user equipment into contact with an NFC tag and/or RFID tag of first clothing, and sends information about the first clothing to the server 400 through his/her account, the information about the first clothing may be engaged with the account of the first user U1 and stored. That is, the first clothing may be classified and stored as the clothing owned by the first user U1.

On the other hand, when a second user U2 brings his/her user equipment into contact with an NFC tag and/or RFID tag of second clothing, and sends information about the second clothing to the server 400 through his/her account, the information about the second clothing may be engaged with the account of the second user U2 and stored. That is, the second clothing may be classified and stored as the clothing owned by the second user U2.

The user equipment may refer to any device equipped with a short-range communication module such as an NFC chip and/or an RFID chip and a radio communication module for communicating with the server 400 over the Internet, and for example, may include a smartphone.

As such, the server 400 may collect information about clothes owned by the first user U1 and information about clothes owned by the second user U2.

In another example, when there is no NFC tag and/or RFID tag attached to the clothing, the server 400 may collect clothing information based on an image obtained by a camera installed at home.

Specifically, the camera installed at home may obtain and transmit an image of the user to the server 40, and the server 400 may recognize clothing worn by the user based on the image of the user transmitted from the camera, and compare the recognized clothing with clothes stored in a database to create clothing information. Furthermore, the server 400 may recognize a face of the user from the image of the user, link the recognized clothing to user information and store the result.

Specifically, the server 400 may determine a corresponding user account by comparing a face image of a user stored in a user account with a face image of the user recognized based on the image of the user obtained from the camera.

For this, it is desirable for the camera to be installed near a front door of the house to capture an image of a user going out or coming home and prevent security issues, and may include a radio communication module to communicate with the server 400.

Furthermore, the camera may be woken up only when a motion of an object is detected by a motion sensor installed around the front door, thereby preventing unnecessary power consumption, and transmit an image to the server 400 only when there is a change in pixel of the received image data, thereby preventing data consumption due to unnecessary image transmission.

How the server 400 links clothing information to user information and stores the result is not limited to the aforementioned method, but any method that links clothing information to user information and stores the result may be used.

As such, the server 400 may store information about a plurality of users and information about clothes owned by the plurality of users.

Referring to FIG. 2, in an embodiment, the clothing treatment device 100 may include a communicator 120 enabling communication with an external device, a storage 130 for storing various information, a display 140 for providing a user interface to provide various information for the user, a camera 150 for capturing an object, a motion sensor 155 for detecting a motion of the object, a microphone 160 for receiving a voice signal of the object, and a controller 110 for controlling various components of the clothing treatment device 100.

The controller 110 may include at least one memory storing a program and data for controlling the various components of the clothing treatment device 100, and a microprocessor for performing computations to control operations of the various components of the clothing treatment device 100 according to the program and data stored in the at least one memory. The memory and the processor of the controller 110 may be integrated in one chip or may be provided separately.

The communicator 120 may transmit data to an external device or receive data from an external device under the control of the controller 110. For example, the communicator 120 may communicate with the server 400 to transmit information relating to clothing of a user and receive status information of the clothes owned by the user from the server 400.

For this, the communicator may include a radio communication module and/or a short-range communication module for communicating with the server 400 and/or other home appliances 200 and 300.

The server 400 may send clothing information linked to the user information and stored to the communicator 120, and the controller 110 may store the clothing information received through the communicator 120 in the storage 130.

The camera 150 may have a capturing range directed to the front of the clothing treatment device 100 to capture an object located in front of the clothing treatment device 100. The camera 150 may send an image obtained by capturing an object to the controller 110, and the controller 110 may recognize the object captured by the camera 150, control the communicator to request individualized information from the server 400 according to what user the recognized object is, and control the display 140 to provide the individualized information.

For example, the controller 110 may control the display 140 to provide a first user interface UI1 for providing status information of clothes owned by the first user U1 when an object captured by the camera 150 is determined as the first user U1, and control the display 140 to provide a second user interface U12 for providing status information of clothes owned by the second user U2 when an object captured by the camera 150 is determined as the second user U2.

The motion sensor 155 may have a sensing range directed to the front of the clothing treatment device 100 to detect a motion of an object located in front of the clothing treatment device 100. For this motion sensor 155, various sensors capable of detecting a motion of an object may be used. The camera 150 may be woken up only when a motion of an object is detected by the motion sensor 155, thereby preventing unnecessary power consumption. The camera 110 may generate a control signal to wake up the camera 150 based on an output value detected by the motion sensor 155.

The microphone 160 may receive a voice signal of the user and send the voice signal to the controller 110, and the controller 110 may identify the user based on the voice signal received from the microphone 160, control the communicator 120 to request individualized information from the server 400 according to a result of the identifying and control the display 140 to provide the individualized information.

For example, when a motion of an object is detected by the motion sensor 155 and a voice signal is received from the microphone 160, the controller 110 may identify a user based on the voice signal received from the microphone 160.

Furthermore, the controller 110 may identify a user based on a voice signal received from the microphone 160 when the voice signal received from the microphone 160 corresponds to a preset wakeup signal.

The display 140 may provide an individualized user interface under the control of the controller 110.

The display 140 may be implemented with a touch screen, in which case the display 140 may include a touch panel that receives a user input.

The display panel 140 may employ a cathode ray tube (CRT) display panel, a liquid crystal display (LCD) panel, a light emitting diode (LED) panel, an organic LED (OLED) panel, a plasma display panel (PDP), a field emission display (FED) panel, etc. The type of the display panel is not limited thereto, and any display means capable of visually presenting an optical image corresponding to image data may be the display panel. Furthermore, a polarizing panel including a mirror film may be provided on the display panel, and accordingly, the display 140 may be implemented as a mirror display.

Moreover, the display 140 may use a touch panel that detects a touch of the user and sends an electric signal corresponding to coordinates of a point touched by the user to the controller 110. The controller 110 may obtain the coordinates of the point touched by the user based on an electric signal received from the touch panel, and provide various information to the user based on the coordinates of the touch point.

The touch panel included in the display 140 may employ a resistive touch panel or a capacitive touch panel. The touch panel is not, however, limited thereto, and the touch panel may employ various input means capable of detecting a touch or approach of the user and outputting an electric signal corresponding to coordinates of the detected touch point or approaching point.

In an embodiment, the washing machine 200 may include a communicator 220 for communicating with an external device, a storage 230 for storing various information, a sensor module 240 for obtaining maintenance information of the washing machine 200, and a controller 210 for controlling various components of the washing machine 200.

The controller 210 may include at least one memory storing a program and data for controlling the various components of the washing machine 200, and a microprocessor for performing computations to control operations of the various components of the washing machine 200 according to the program and data stored in the at least one memory. The memory and the processor of the controller 210 may be integrated in one chip or may be provided separately.

The communicator 220 may include a radio communication module for communicating with the server 400, and a short-range communication module for communicating with the NFC tag and/or the RFID tag attached to clothing.

The radio communication module included in the communicator 220 may receive clothing information of clothes owned by the user from the server 400, and the controller 210 may store the clothing information received from the server 400 in the storage 230.

The short-range communication module included in the communicator 220 may include an NFC reader, which may be arranged on the main body of the washing machine 200. When the user brings an NFC tag attached to clothing into contact with the NFC reader arranged on the washing machine 200, the NFC reader may receive clothing information included in the NFC tag attached to the clothing and send the clothing information to the controller 210.

Furthermore, the short-range communication module included in the communicator 220 may include an RFID reader and/or an RFID antenna. The RFID reader and/or the RFID antenna may be arranged on the washing machine 200. For example, the RFID reader may be arranged on the rear surface of the main body of the washing machine 200 and the RFID antenna may be arranged on an inner surface of the door of the washing machine 200. There are no limitations on the number of RFID readers and/or RFID antennas arranged on the washing machine 200, and the RFID reader and/or RFID antenna may be provided in the plural. For example, there may be two RFID antennas arranged on the washing machine 200.

When the user puts clothing with an RFID tag attached thereto inside the door of the washing machine 200, the RFID reader and/or the RFID antenna arranged in the washing machine 200 may receive clothing information included in the RFID tag attached to the clothing and send the clothing information to the controller 210.

The controller 210 may compare the clothing information received from the short-range communication module such as the NFC reader and/or the RFID reader and/or the RFID antenna with clothing information stored in the storage 230, and control a speaker of the washing machine 200 to output a preset sound or control the display of the washing machine 200 to output preset words.

For example, when cloth included in the clothing information received from the short-range communication module is wool, the controller 210 may control the speaker and/or the display of the washing machine 200 to output a sound or words requesting separate washing.

Furthermore, when the washing machine 200 is operated after the clothing information is received from the short-range communication module, the controller 210 may control the communicator 220 to send laundry information of the clothing to the server 400. In other words, the controller 210 may control the communicator 220 to send laundry information of clothes owned by the user to the server 400. In this case, the laundry information may include all information relating to washing such as washing date information, washing time information, washing course information, etc., of the clothing.

The laundry information may be stored in the storage 230, and the controller 210 may transmit the laundry information to the server 400 in response to a laundry information request signal received from the clothing treatment device 100 through the server 400.

The controller 210 may control the communicator 220 to send information indicating that laundry of the clothing has been completed when the door is opened after the washing machine 200 is operated.

The sensor module 240 may include various sensors capable of obtaining maintenance information of the washing machine 200. For example, the sensor module 240 may include various sensors such as a sensor for detecting the number of operation times of the washing machine 200, a sensor for detecting whether the door of the washing machine 200 is closed, a sensor for detecting rotation of a fan of the washing machine 200, a sensor for detecting an amount of detergent supplied to a detergent container of the washing machine 200, etc.

Maintenance information of the washing machine 200 may include information about a factor that may cause damage to clothes, information about a factor that may cause performance degradation of the washing machine 200, etc. In other words, the maintenance information of the washing machine 200 may include information for maintenance of the washing machine 200.

For example, the maintenance information of the washing machine 200 may include various information such as information indicating that the detergent container runs low on detergent, information indicating that a filter of the washing machine 200 needs to be replaced, information indicating that the interior of the washing machine 200 needs to be cleaned, information indicating that laundry in the washing machine 200 needs to be removed, etc.

In an embodiment, the dryer 300 may include a communicator 320 for communicating with an external device, a storage 330 for storing various information, a sensor module 340 for obtaining maintenance information of the dryer 300, and a controller 310 for controlling various components of the dryer 300.

The controller 310 may include at least one memory storing a program and data for controlling the various components of the dryer 300, and a microprocessor for performing computations to control operations of the various components of the dryer 300 according to the program and data stored in the at least one memory. The memory and the processor of the controller 310 may be integrated in one chip or may be provided separately.

The communicator 320 may include a radio communication module for communicating with the server 400, and a short-range communication module for communicating with the NFC tag and/or the RFID tag attached to clothing.

The radio communication module included in the communicator 320 may receive clothing information of clothes owned by the user from the server 400, and the controller 310 may store the clothing information received from the server 400 in the storage 330.

The short-range communication module included in the communicator 320 may include an NFC reader, which may be arranged on the main body of the dryer 300. When the user brings an NFC tag attached to clothing into contact with the NFC reader arranged on the washing machine 200, the NFC reader may receive clothing information included in the NFC tag attached to the clothing and send the clothing information to the controller 310.

Furthermore, the short-range communication module included in the communicator 320 may include an RFID reader and/or an RFID antenna. The RFID reader and/or the RFID antenna may be arranged in the dryer 300. For example, the RFID reader may be arranged on the rear surface of the main body of the dryer 300 and the RFID antenna may be arranged on an inner surface of the door of the dryer 300. There are no limitations on the number of RFID readers and/or RFID antennas arranged on the dryer 300, and the RFID reader and/or RFID antenna may be provided in the plural. For example, there may be two RFID antennas arranged on the dryer 300.

When the user puts clothing with an RFID tag attached thereto inside the door of the dryer 300, the RFID reader and/or the RFID antenna arranged on the dryer 300 may receive clothing information included in the RFID tag attached to the clothing and send the clothing information to the controller 310.

The controller 310 may compare the clothing information received from the short-range communication module such as the NFC reader and/or the RFID reader and/or the RFID antenna with clothing information stored in the storage 330, and control a speaker of the dryer 300 to output a preset sound or control the display of the dryer 300 to output preset words.

For example, when cloth included in the clothing information received from the short-range communication module is wool, the controller 310 may control the speaker and/or the display of the dryer 300 to output a sound or words requesting to perform a wool course.

Furthermore, when the dryer 300 is operated after the clothing information is received from the short-range communication module, the controller 310 may control the communicator 320 to send dry information of the clothing to the server 400. In other words, the controller 310 may control the communicator 320 to send dry information of clothing owned by the user to the server 400. In this case, the dry information may include all information relating to drying such as drying date information, drying time information, drying course information, etc., of the clothing.

The dry information may be stored in the storage 330, and the controller 310 may transmit the dry information to the server 400 in response to a dry information request signal received from the clothing treatment device 100 through the server 400.

The controller 310 may control the communicator 320 to send information indicating that drying of the clothing has been completed when the door is opened after the dryer 300 is operated.

The sensor module 340 may include various sensors capable of obtaining maintenance information of the dryer 300. For example, the sensor module 340 may include various sensors such as a sensor for detecting the number of operation times of the dryer 300, a sensor for detecting whether the door of the dryer 300 is closed, a sensor for detecting rotation of a fan of the dryer 300, a sensor for detecting internal temperature of the dryer 300, a sensor for detecting a water level in a drainage basin of the dryer 300, etc.

Maintenance information of the dryer 300 may include information about a factor that may cause damage to clothes, information about a factor that may cause performance degradation of the dryer 300, etc. In other words, the maintenance information of the dryer 300 may include information for maintenance of the dryer 300.

For example, the maintenance information of the dryer 300 may include information indicating that a filter of the dryer 300 needs to be replaced, information indicating that the filter of the dryer 300 needs to be cleaned, information indicating that the interior of the dryer 300 needs to be dried, information indicating that the laundry in the dryer 300 needs to be removed, information indicating that the drainage basin needs to be emptied, information indicating that an exhaust port of the dryer 300 needs to be checked, etc.

In an embodiment, the server 400 may include a communicator 420 for communicating with an external device, a storage 430 for storing various information, and a controller 410 for controlling various components of the server 400.

The controller 410 may include at least one memory storing a program and data for controlling the various components of the server 400, and a microprocessor for performing computations to control operations of the various components of the server 400 according to the program and data stored in the at least one memory.

The communicator 420 may receive an information request signal sent from the communicator 120 of the clothing treatment device 100 and forward the information to the controller 410.

The controller 410 may control the communicator 420 to transmit information corresponding to the information request signal sent from the communicator 420.

The communicator 420 may include a radio communication module for communicating with various home appliances such as the clothing treatment device 100, the washing machine 200 and the dryer 300 and a user equipment of the user.

The storage 430 may store various information received from communicator 420.

For example, the storage 430 may store clothing information received from the user equipment, laundry information received from the washing machine 200, dry information received from the dryer 300, etc.

Furthermore, the storage 430 may store information about an account assigned to each user, and also store clothing information in information about the account.

Although not shown in FIGS. 1 and 2, a wardrobe (not shown) located at home may include a short-range communication module for communicating with an NFC tag and/or an RFID tag attached to clothing, and a radio communication module for communicating with the server 400.

The short-range communication module equipped in the wardrobe may include an RFID reader and/or an RFID antenna. For example, the RFID reader and/or the RFID antenna may be equipped in the wardrobe, and may not be limited in number and may be provided in the plural.

When the user puts clothing with an RFID tag attached thereto into the wardrobe, the RFID reader and/or the RFID antenna arranged in the wardrobe may receive clothing information included in the RFID tag attached to the clothing and send the clothing information to the server 400. In other words, the wardrobe placed at home may transmit location information of clothes to the server 400, and the storage 430 may store the location information of clothes owned by a plurality of users.

As such, the storage 430 may store status information of clothes owned by a plurality of users. The status information of clothes may include various information of clothes such as laundry information, dry information, location information, information about the number of wearing times, wearing date information, etc., of the clothes.

The aforementioned radio communication module may include at least one of various radio communication modules that may access the Internet in a wireless communication scheme, such as wireless fidelity (Wi-Fi), wireless broadband (Wibro), global system for mobile communication (GSM), code division multiple access (CDMA), wideband code division multiple access (WCDMA), universal mobile telecommunications system (UMTS), time division multiple access (TDMA), long term evolution (LTE), fourth generation (4G) mobile communication, fifth (5G) generation mobile communication, etc.

Furthermore, the short-range communication module may include at least one of various short-range communication modules for transmitting and receiving signals within a short range over a wireless communication network, such as Bluetooth module, an infrared communication module, an RFID communication module, a wireless local access network (WLAN) communication module, a near field communication (NFC) module, a Zigbee communication module, etc.

Moreover, for convenience of explanation, each of the components 100, 200 and 300 in the clothing treatment system is described to have a form of exchanging information with each other via the server 400, but it is also possible that the components of the clothing treatment system may communicate directly with each other by using the short-range communication modules.

The aforementioned storages 130, 230, 330, and 430 may include a non-volatile memory that preserves the stored program or data even when the power is out. For example, the storages 130, 230, 330, and 430 may include a bulk flash memory, a solid state drive (SSD), or the like.

Furthermore, the storages 130, 230, 330 and 430 may further include a volatile memory that temporarily stores data. The volatile memory may store data temporarily required for data processing or computation.

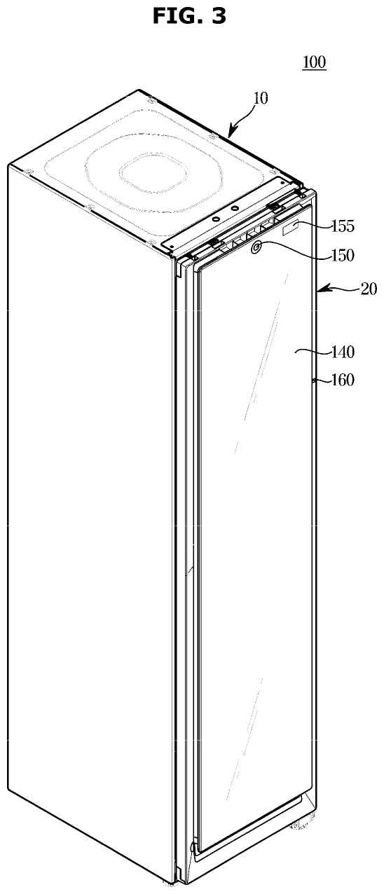

Referring to FIGS. 3 to 5, the clothing treatment device 100 will now be described in detail.

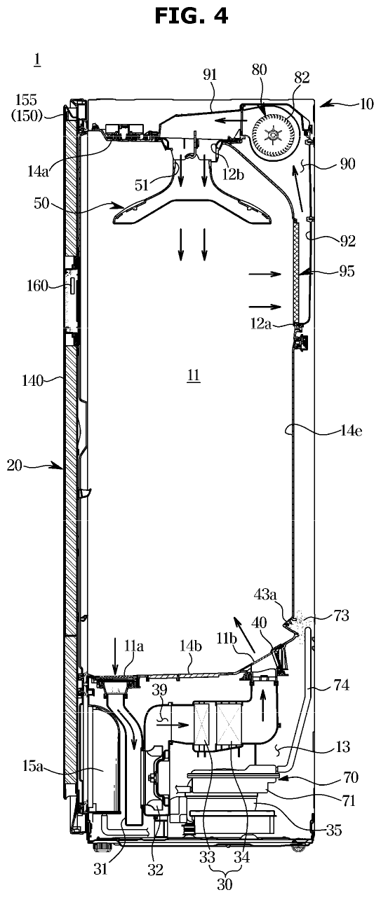

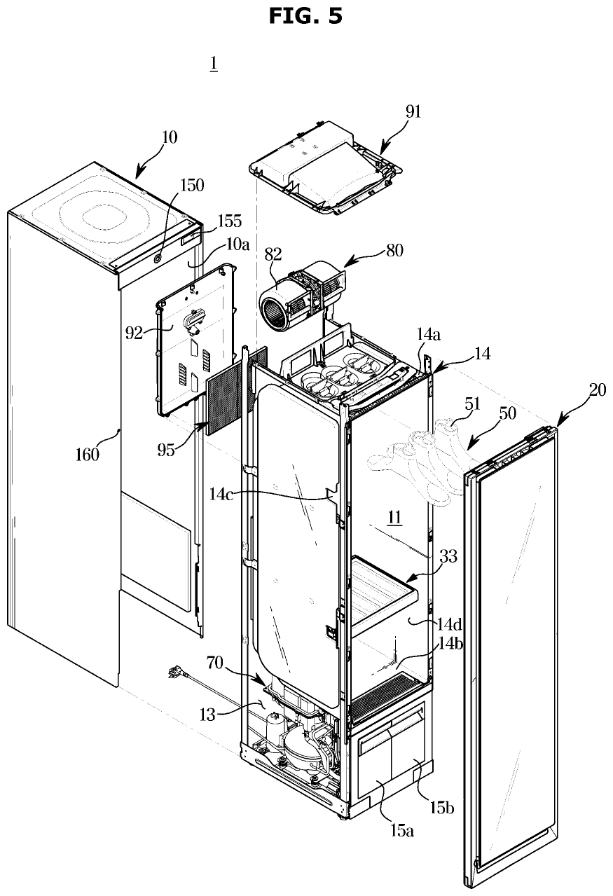

FIG. 3 is a perspective view illustrating a clothing treatment device, according to an embodiment, FIG. 4 is a cross-sectional view illustrates a clothing treatment device, according to an embodiment, and FIG. 5 is an exploded perspective view of a clothing treatment device, according to an embodiment.

Referring to FIGS. 3 to 5, the clothing treatment device 100 may include a main body 10 defining external appearance, a door 20 rotationally coupled to the main body 10, a clothing care room 11 arranged in the main body 10 for accommodating and taking care of clothes, a garment support member 50 provided in the clothing care room 11 to have clothes hung thereon, and a machine room 13 equipped with a heat exchange device 30 provided to dehumidify or heat air in the clothing care room 11.

The main body 10 may form the clothing care room 11 inside, and may be shaped like a rectangular parallelepiped with one side open. An opening 10a may be formed on the front of the main body 10. The door 20 is installed at the opening 10a of the main body 10 to be rotationally coupled to the opening 10a for opening or closing the main body 10. The door 20 is installed to open or close the clothing care room 11. The door 20 may be installed at the main body 10 through a coupling member such as a hinge.

The display 140 for providing various information for the user may be arranged on the front surface of the door 20. The display 140 may be implemented in the form of a mirror display or a touch screen.

On an upper portion of the main body 10, there may be a camera 150 that has a capturing region of the front of the clothing treatment device 100 to capture an object located in front of the clothing treatment device 100 and the motion sensor 155 that has a detection region of the front of the clothing treatment device 100 to detect a motion of an object located in front of the clothing treatment device 100. However, the camera 150 or the motion sensor 155 may be installed at any location that may recognize a user in front of the clothing treatment device 100 without limitation.

Furthermore, the microphone 160 for detecting a voice signal of the user may be arranged on a side of the main body 10. However, the microphone 160 may be installed at any location that may receive a voice signal of a user around the clothing treatment device 100 without limitation.

The clothing care room 11 may be formed with a top surface 14a, a bottom surface 14b, a left surface 14c, a right surface 14d and a rear surface 14e arranged on an inner cabinet 14.

The clothing care room 11 forms a space to receive clothes. The garment support member 50 may be provided in the clothing care room 11 for clothes to be hung and supported thereon. The garment support member 50 may be detachably installed in an upper portion of the clothing care room 11. There may be at least one or more garment support members 50. The garment support member 50 may be shaped like a hanger to hang clothes. The garment support member 50 is provided to allow air to move in the garment support member 50. Dust or foreign materials on the clothes may be removed by the air supplied into the garment support member 50.

The clothing care room 11 may include a first air current inlet 11a and a second air current inlet 12a, a first air current outlet 11b and a second air current outlet 12b, and a steam outlet 43a. The first air current inlet 11a and the first air current outlet 11b may be formed on the bottom side of the clothing care room 11. The first air current inlet 11a may be arranged in a front portion of the bottom side of the clothing care room 11, and the first air current outlet 11b may be arranged in a rear portion of the bottom side of the clothing care room 11. The second air current inlet 12a may be formed on the rear side of the clothing care room 11. The second air current outlet 12b may be formed in the center of the top side of the clothing care room 11. The second air current inlet 12a and the second air current outlet 12b may be arranged close to each other.

An exhaust grill 40 may be arranged at the first air current outlet 11b for the air to diffuse well inside the clothing care room 11.

The second air current outlet 12b of the clothing care room 11 may be connected to the garment support member 50. Air discharged through the second air current outlet 12b is delivered to clothes hung on the garment support member 50 through an air hole 51 formed on the garment support member 50.

A drain tub 15a and a water supply tub 15b may be installed in a lower portion of the main body 10 to be detachable from the main body 10. The drain tub 15a and the water supply tub 15b may be arranged underneath the clothing care room 11. The drain tub 15a is provided to facilitate disposal of condensate water. Water required to generate steam in the steam generating device 70, which will be described later, may be stored in the water supply tub 15b. The water stored in the water supply tub 15b is supplied to the steam generating device 70 to be used to produce steam. The water supply tub 15b may be installed to be detachable from the main body 10 for easy water replenishment.

The drain tub 15a and the water supply tub 15b may be arranged in front of a machine room 13. The machine room 13 is arranged in a lower portion of the main body 10. The machine room 13 is arranged under the clothing care room 11. The machine room 13 may include a heat exchange device 30 provided to dehumidify and heat air in the clothing care room 11 as needed.

A wind blower fan 32, the heat exchange device 30, and the steam generating device 70 may be arranged in the machine room 13.

The wind blower fan 32 may suck air into the machine room 13, and move the air into the clothing care room 11 from the bottom of the clothing care room 11. In other words, the wind blower fan 32 may move the air from the bottom of the clothing care room 11 in an upward direction of the clothing care room 11. The wind blower fan 32 may include a motor for generating rotational force and blades arranged to be rotated by the motor.

The wind blower fan 32 may be provided as a centrifugal fan that sucks in air in an axial direction and discharges air to the outside of the radial direction.

The air moved by the wind blower fan 32 may be dried through the heat exchange device 30. With this, the clothes present in the clothing care room 11 may expose to the dried air from the bottom of the clothing care room 11.

The heat exchange device 30 is installed to supply hot air into the clothing care room 11. The heat exchange device 30 includes an evaporator 33, a compressor 35, and a condenser 34 for circulation of a refrigerant, and is provided to dehumidify and heat air.

The refrigerant absorbs latent heat of surrounding air while evaporating in the evaporator 33 of the heat exchange device 30, condensing and eliminating moisture in the air. Furthermore, when the refrigerator is condensed in the condenser 34 via the compressor 35, the refrigerator radiates latent heat to surrounding air, thereby heating the surrounding air. That is, the evaporator 33 and the condenser 34 serve as a heat exchanger, so that air brought by the wind flow fan 32 into the machine room 13 sequentially passes the evaporator 33 and the condenser 34 to be dehumidified and heated.

The heat exchange device 30 installed in the machine room 13 may include a first duct 31 connecting between the evaporator 33, the condenser 34, and the wind blower fan 32, and the first duct 31 may be connected to the clothing care room 11 to form a first circulation path 39 rotating between the clothing care room 11 and the first duct 31.

The first duct 31 may be connected to the first air current inlet 11a and the first air current outlet 11b of the clothing care room 11. The air in the clothing care room 11 flows into the first duct 31 through the first air current inlet 11a, in which the air is dehumidified, and released back into the clothing care room 11 through the first air current outlet 11b.

The first duct 31 is provided to dehumidify air flowing in through the first air current inlet 11a and release the air through the first air current outlet 11b. The wind blower fan 32 is arranged in the first duct 31 to suck air of the clothing care room 11 into the first duct 31.

The air inside the clothing care room 11 may flow into the first circulation path 39 through the first air current inlet 11a. The air brought in may be dehumidified and heated while passing through the heat exchange device 30, and the dehumidified and heated air may be released back into the clothing care room 11 through the first air current outlet 11b.

The steam generating device 70 may be arranged in the machine room 13. The steam generating device 70 may form steam with water received from the water supply tub 15b in the machine room 13.

The steam generating device 70 may include a steam generator 71 connected to the water supply tub 15b for receiving water therefrom to generate steam, and a steam supply pipe 74 for guiding the generated steam to a steam injector 73, which will be described below. The steam injector 73 may be arranged in a lower portion of the rear side of the clothing care room 11. A heater (not shown) is installed inside the steam generator 71 to heat water.

The clothing care room 11 may include a wind blower device 80 for moving air in the clothing care room 11. The clothing care room 11 may include a second duct 91, and the wind blower device 80 may be installed inside the second duct 91. A second circulation path 90 may be formed in the second duct 91 to be linked to the clothing care room 11 to rotate between the clothing care room 11 and the second duct 91. The wind blower device 80 may be arranged in the second circulation path 90. The second duct 91 and 92 may be formed behind the second air current inlet 12a of the clothing care room 11. The second duct 91 may be arranged in an upper portion of the rear side of the clothing care room 11, and may include a filter 95 inside.

The wind blower device 80 may include a wind blower fan 82.

The wind blower fan 82 may be arranged above the clothing care room 11. The wind blower fan 82 may move the air from the top of the clothing care room 11 in a downward direction of the clothing care room. The wind blower fan 82 may include a motor for generating rotational force and blades rotated by the motor.

The wind blower fan 82 may be provided as a centrifugal fan that sucks in air in an axial direction and discharges air to the outside of the radial direction.

The wind blower fan 82 arranged above the clothing care room 11 may be referred to as an upper fan or a first fan, and a motor arranged with the first fan may be referred to as a first motor.

The wind blower fan 32 arranged under the clothing care room 11 may be referred to as a lower fan or a second fan, and a motor arranged with the second fan may be referred to as a second motor.

The second duct 91 may be connected to the second air current inlet 12a and the second air current outlet 12b of the clothing care room 11. The second air current outlet 12b is connected to the garment support member 50 so that the air in the second duct 91 flows to the garment support member 50.

The wind blower device 80 arranged inside the second duct 91 sucks in air in the clothing care room 11 through the second air current inlet 12a and releases the air through the second air current outlet 12b.

When the air in the clothing care room 11 flows into the second duct 91, the air may be filtered by the filter 95 at the second air current inlet 12a. The air flowing into the second duct 91 may be dusted and deodorized by the filter 95.

The clothing treatment device 100 is operated while clothes are hung on the garment support member 50 and the door 20 is closed. In this case, air is circulated along the first circulation path 39 and the second circulation path 90 in the clothing care room 11.

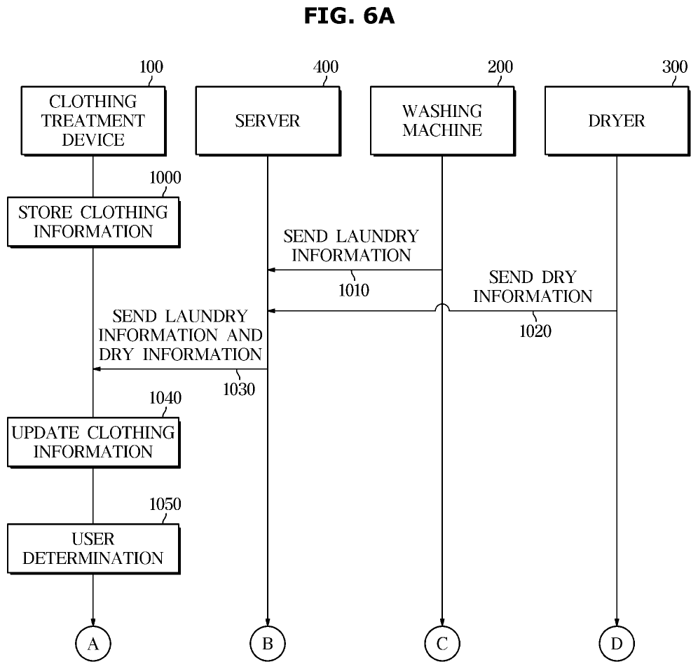

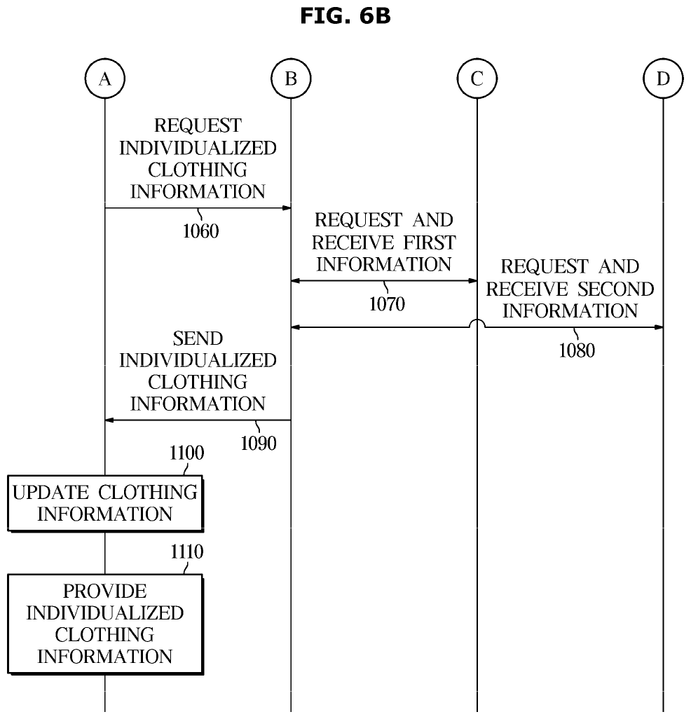

A structure of the clothing treatment device 100 has thus far been described in detail. Operations of each component of a clothing treatment system will now be described with reference to FIGS. 6A, 6B, and 7 to 10.

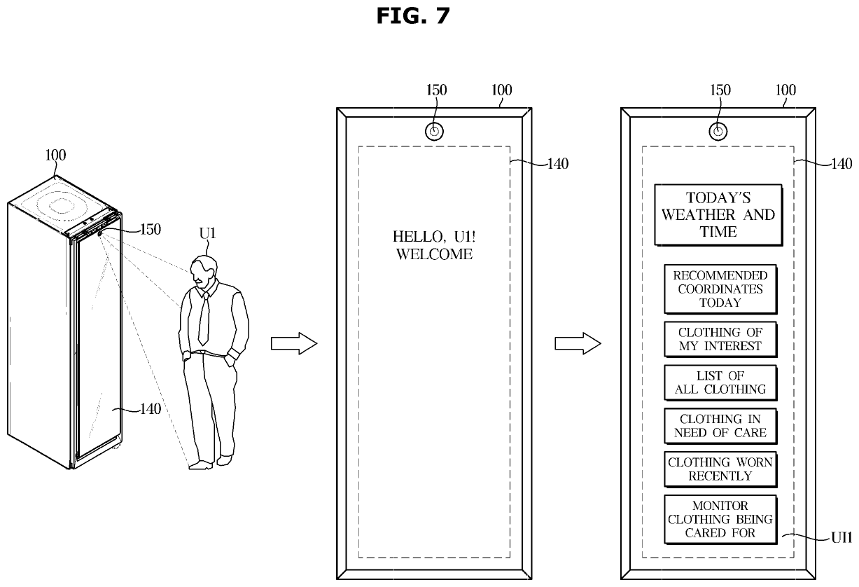

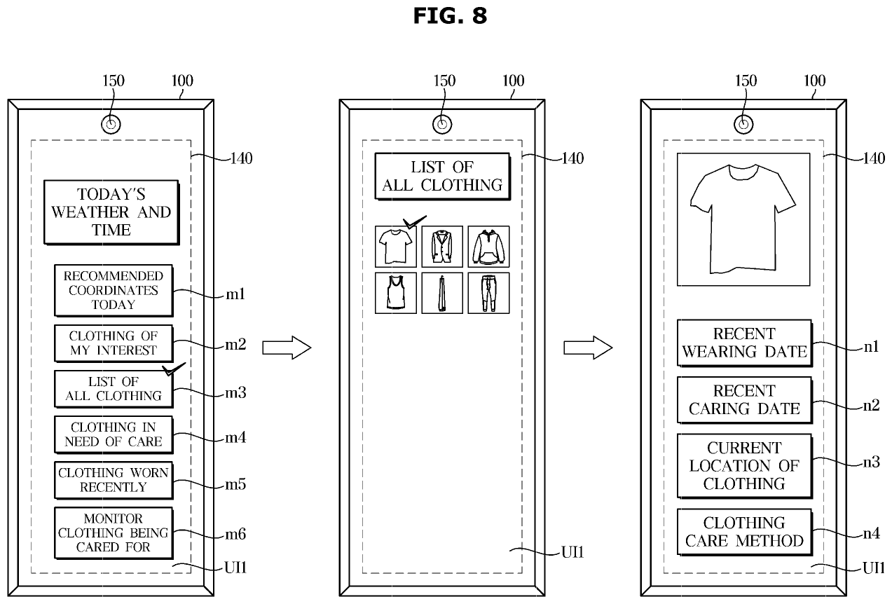

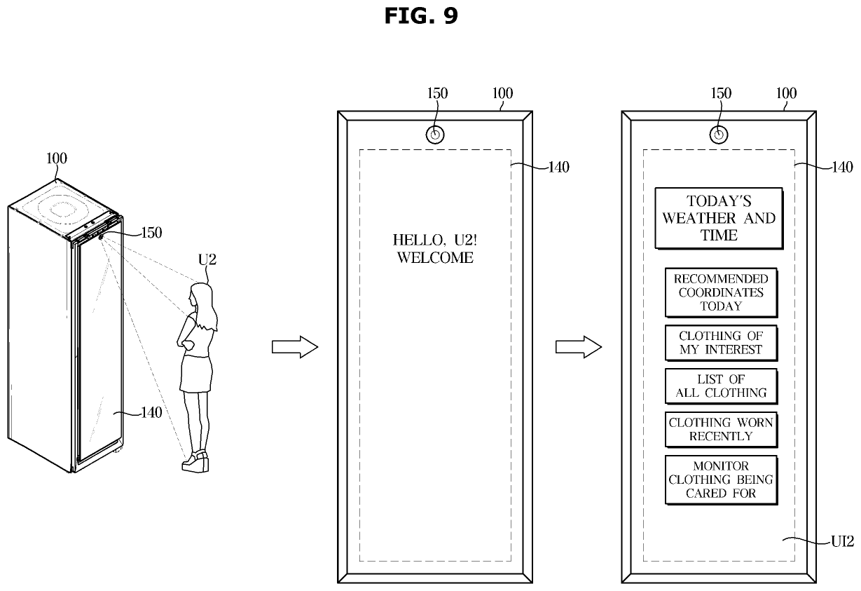

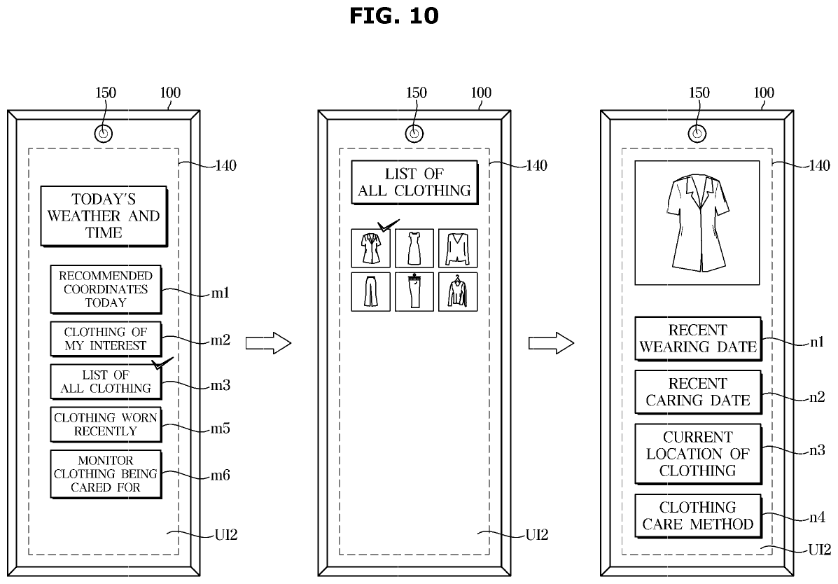

FIGS. 6A and 6B are a flowchart illustrating operations of a clothing treatment system, according to an embodiment, FIGS. 7 and 8 are diagrams for describing individualized clothing information provided for a first user, and FIGS. 9 and 10 illustrate examples of individualized clothing information provided to a second user.

Referring to FIG. 6A, the clothing treatment device 100 may store status information of clothes owned by a plurality of users including the first user U1 and the second user U2, in 1000.

For example, the plurality of users including the first user U1 and the second user U2 may be family members at home, and the status information of the clothes may include laundry information, dry information, location information, information about the number of wearing times and wearing date information, etc.

When the user puts clothing with an RFID tag attached thereto to the inside of the door of the washing machine 200 or brings the clothing with the RFID tag attached thereto into contact with an NFC reader equipped in the washing machine 200, the washing machine 200 may send laundry information to the server 400, in 1010.

When the user puts clothing with an RFID tag attached thereto to the inside of the door of the dryer 300 or brings the clothing with the RFID tag attached thereto into contact with an NFC reader equipped in the dryer 300, the dryer 300 may send dry information to the server 400, in 1020.

Although not shown, a wardrobe equipped with an NFC reader and/or an RFID reader/antenna may send location information of clothes to the server 400.

The server 400 may send the laundry information received from the washing machine 200 and/or the dry information received from the dryer 300 and/or the location information of clothes to the clothing treatment device 100, in 1030.

For example, the server 400 may send the laundry information and/or the dry information to the clothing treatment device 100 in response to receiving the laundry information and/or the dry information from the washing machine 200 and/or the dryer 300, or send the laundry information and/or the dry information to the clothing treatment device 100 in response to receiving a signal to request laundry information and/or dry information from the clothing treatment device 100.

The clothing treatment device 100 may update the status information of clothes owned by a plurality of users based on the laundry information and/or the dry information and/or the location information received from the server 400, in 1040.

For example, on receiving laundry information indicating that washing of the first clothing owned by the first user U1 is completed, the clothing treatment device 100 may update the washing date of the first clothing owned by the first user U1. Furthermore, on receiving dry information indicating that drying of the second clothing owned by the second user U2 is completed, the clothing treatment device 100 may update the drying date of the second clothing owned by the second user U2. Moreover, on receiving location information indicating that the second clothing owned by the second user U2 is located in the wardrobe, the clothing treatment device 100 may update the location of the second clothing owned by the second user U2.

As such, the clothing treatment device 100 may store and update the status information of clothes owned by the plurality of users to figure out recent status information of the clothes owned by each of the plurality of users, thereby acting as a hub in the clothing treatment system.

Specifically, the clothing treatment device 100 may provide individualized clothing status information based on an object captured by the camera 150.

For this, the clothing treatment device 100 may determine what user the object captured by the camera 150 is, in 1050.

For example, the clothing treatment device 100 may process an image obtained through the camera 150 and recognize a facial image of a user, and compare the recognized facial image with a facial image stored in the storage 130 to determine what user an object located in front of the clothing treatment device 100 is.

Furthermore, the clothing treatment device 100 may process an image obtained through the camera 150 and recognize an image of clothing worn by the user, and compare the recognized clothing image with clothing images stored in the storage 130 to determine what user an object located in front of the clothing treatment device 100 is. Specifically, the controller 110 may compare the image of the clothing worn by the user with clothing images stored in the storage 130 to determine a clothing image with highest similarity, and when the clothing image with the highest similarity is about clothing of the first user U1, may determine the object located in front of the clothing treatment device 100 as the first user U1.

There are no limitations to the determining of what user the object captured by the camera 150 is, and any method of identifying a user may be used.

For example, when a motion of an object is detected by the motion sensor 155 or a particular object is recognized by the camera 150, and a voice signal of a user is input through the microphone 160, the clothing treatment device 100 may determine what user the object located in front of the clothing treatment device 100 is by comparing the voice signal received through the microphone 160 with voice signals stored in the storage 130.

Referring to FIG. 6B, the clothing treatment device 100 may provide individualized clothing information for a corresponding user through the display 140 depending on what user the object captured by the camera 150 is, in 1110.

Specifically, the clothing treatment device 100 may provide the first user interface UI1 for providing status information of clothes owned by the first user U1 through the display 140 when an object captured by the camera 150 is determined as the first user U1, and provide the second user interface UI2 for providing status information of clothes owned by the second user U2 through the display 140 when an object captured by the camera 150 is determined as the second user U2.

A procedure in which the server 400 sends laundry information and/or dry information and/or location information of clothes owned by the plurality of users to the clothing treatment device 100 without request from the clothing treatment device 100 is described in connection with FIG. 6A, but various embodiments may be used for a procedure in which the clothing treatment device 100 updates the clothing information.

Specifically, referring to FIG. 6B, the clothing treatment device 100 may request individualized clothing information from the server 400 based on what user the object captured by the camera 150 is, in 1060.

For example, when the object captured by the camera 150 is determined as the first user U1, the clothing treatment device 100 may request laundry information and/or dry information and/or location information of the clothes owned by the first user U1 from the server 400.

When the server 400 receives laundry information from the washing machine 200 in real time and stores the information in the storage 430, receives dry information from the dryer 300 in real time and stores the information in the storage 430, and receives location information from the wardrobe in real time and stores the information in the storage 430, the server 400 may send individualized clothing information to the clothing treatment device 100 in response to the request signal received from the clothing treatment device 100, in 1090, without need to request laundry information and/or dry information and/or location information from the washing machine 200 and/or the dryer 300 and/or the wardrobe.

According to the embodiment, the storage 430 of the server 400 may bear the limited storage capacity of the storage 130 of the clothing treatment device 100 and/or the storage 230 of the washing machine 200 and/or the storage 330 of the dryer 300.

On receiving the request for individualized clothing information from the clothing treatment device 100, the server 400 may request individualized laundry information (hereinafter, first information) and receive the first information from the washing machine 200 in 1070, and request individualized dry information (hereinafter, second information) and receive the second information from the dryer 300 in 1080.

For example, the clothing treatment device 100 may request status information of clothes owned by the first user U1 from the server 400 when an object captured by the camera 150 is determined as the first user U1, and the server 400 may request laundry information (first information) of the clothes owned by the first user U1 from the washing machine 200 and dry information (second information) of the clothes owned by the first user U1 from the dryer 300 in response to the request of the clothing treatment device 100.

Similarly, the server 400 may send the first information and the second information to the clothing treatment device 100 in response to receiving the first information and the second information, in 1090.

Although not shown, when receiving a request for individualized clothing information from the clothing treatment device 100, the server 400 may request location information of individualized clothes from the wardrobe, receive the location information of the individualized clothes, and send the information to the clothing treatment device 100.

According to the aforementioned embodiment, a burden on storage capacity of the storage 430 of the server 400 may be reduced.

As described above, the clothing treatment device 100 may update status information of clothes stored in the storage 130 based on the individualized clothing information received from the server 400, in 1100.

Also, the clothing treatment device 100 may recognize the clothing worn by an object captured by the camera 150 and update wearing date information and information about the number of wearing times of the recognized clothing.

For example, when the clothing worn by the object captured by the camera 150 is determined as the first clothing of the first user U1, the wearing date information and the information about the number of wearing times of the first clothing may be updated.

Furthermore, when a wardrobe at home is not equipped with an RFID reader/antenna so may not collect location information of clothes, the clothing treatment device 100 may update location information of the clothes owned by a plurality of users based on the laundry information and the dry information received from the server 400.

For example, when the first clothing owned by the first user U1 is determined as being washed, the clothing treatment device 100 may update the location information of the first clothing as the inside of the washing machine 200, and when the first clothing owned by the first user U1 is determined as being dried, the clothing treatment device 100 may update the location information of the first clothing as the inside of the dryer 300.

Furthermore, when determining that drying of the first clothing is completed and washing of the first clothing is not being performed, the location information of the first clothing may be updated as a wardrobe.

An example of individualized clothing information provided for each user by the clothing treatment device 100 will now be described in connection with FIGS. 7 to 10.

Referring to FIG. 7, when the first user U1 is located in front of the clothing treatment device 100, the controller 110 may determine an object captured by the camera 150 as the first user U1.

When the object captured by the camera 150 is determined as the first user U1, the controller 110 may control the display 140 to provide the first user interface UI1 for providing status information of clothes owned by the first user U1.

For example, the controller 110 may control the display 140 to provide the first user interface UI1 for providing status information of clothes owned by the first user U1, after outputting a welcome image including a name of the first user U1.

Referring to FIG. 8, the first user interface UI1 may include various menus such as a menu m1 for providing recommended coordinates information created based on the status information of the clothes owned by the first user U1, a menu m2 for providing information about clothes registered by the first user U1 as clothes of interest, a menu m3 for providing information about all the clothes owned by the first user U1, a menu m4 for providing information about clothes requiring washing or care by the clothing treatment device 100 among the clothes owned by the first user U1, a menu m5 for providing information about clothes having recently been worn among the clothes owned by the first user U1, a menu m6 for providing information about clothes currently being washed by the washing machine 200 or being dried by the dryer 300 among the clothes owned by the first user U1, etc.

As shown in FIG. 8, in response to a user input to select the menu m3 for providing information about all the clothes owned by the first user U1, the controller 110 may control the display 140 to provide images of all the clothes owned by the first user U1.

Furthermore, in response to a user input to select one of the images of all the clothes owned by the first user U1, the controller 110 may control the display 140 to provide the first user interface UI1 for providing detailed information about the selected clothing.

The first user interface UI1 for providing detailed information about the selected clothing may include various menus such as a menu n1 for providing information about recent wearing date of the selected clothing, a menu n2 for providing information about washing dates and/or drying dates and/or caring dates of the selected clothing, a menu n3 for providing location information of the selected clothing, a menu n4 for providing a caring method of the selected clothing, etc.

For example, the first user interface UI1 for providing detailed information about the selected clothing may also include a menu for providing information about clothes going well with the selected clothing and/or information about clothes having ever been worn with the selected clothing.

Referring to FIG. 9, when the second user U2 is located in front of the clothing treatment device 100, the controller 110 may determine an object captured by the camera 150 as the second user U2.

When the object captured by the camera 150 is determined as the second user U2, the controller 110 may control the display 140 to provide the second user interface UI2 for providing status information of clothes owned by the second user U2.

For example, the controller 110 may control the display 140 to provide the second user interface UI2 for providing status information of clothes owned by the second user U2, after outputting a welcome image including a name of the second user U2.

Referring to FIG. 10, the second user interface UI2 may include various menus such as a menu ml for providing recommended coordinates information created based on the status information of the clothes owned by the second user U2, a menu m2 for providing information about clothes registered by the second user U2 as clothes of interest, a menu m3 for providing information about all the clothes owned by the second user U2, a menu m5 for providing information about clothes having recently been worn among the clothes owned by the second user U2, a menu m6 for providing information about clothes currently being washed by the washing machine 200 or being dried by the dryer 300 among the clothes owned by the second user U2, etc.

Layout and/or placement of the menus included on the second user interface UI2 may be different from the layout and/or placement of the menus included on the first user interface UI1 depending on user information or user settings.

For example, the second user interface UI2 may not include a menu m4 for providing information about clothes requiring washing or care by the clothing treatment device 100 among the clothes owned by the second user U2.

As shown in FIG. 10, in response to a user input to select the menu m3 for providing information about all the clothes owned by the second user U2, the controller 110 may control the display 140 to provide images of all the clothes owned by the second user U2.

Furthermore, in response to a user input to select one of the images of all the clothes owned by the second user U2, the controller 110 may control the display 140 to provide the second user interface UI2 for providing detailed information about the selected clothing.

The second user interface UI2 for providing detailed information about the selected clothing may include various menus such as a menu n1 for providing information about recent wearing date of the selected clothing, a menu n2 for providing information about washing dates and/or drying dates and/or caring dates of the selected clothing, a menu n3 for providing location information of the selected clothing, a menu n4 for providing a caring method of the selected clothing, etc.

To provide the menu ml for providing recommended coordinates information, the controller 110 may create the recommended coordinates information for the user U1 or U2 based on status information of clothes owned by the user U1 or U2 when an object captured by the camera 150 is determined as a particular user U1 or U2.

Specifically, the controller 110 may analyze each of images of all clothes except for clothes being washed, being dried, requiring care, etc., among the clothes owned by the user U1 or U2, and create the recommended coordinates information for the user U1 or U2 by calculating matching scores between the images of the clothes and/or a time, place, occasion (TPO) score of each clothing image.

For this, a neural network model trained with the plurality of clothing images as input data may be used, and the trained neural network model may be stored in the storage 130.

In another example, the neural network model trained with the plurality of clothing images as input data may be stored in the storage 430 of the server 400, and the controller 400 may control the communicator to request recommended coordinates information for the user U1 or U2 from the server 400 so that the recommended coordinates information for the user U1 or U2 may be received from the server 400.

Afterwards, the controller 110 may control the display 140 to provide the recommended coordinates information for the user U1 or U2 in response to a user input to select the menu ml for providing recommended coordinates information.

To provide the menu m4 for providing information about clothes requiring washing, the controller 110 may determine clothing requiring washing among the clothes owned by the plurality of users U1 and U2 based on at least one of laundry information, dry information, information about the number of wearing times and wearing date information of the clothes owned by the plurality of users U1 and U2.

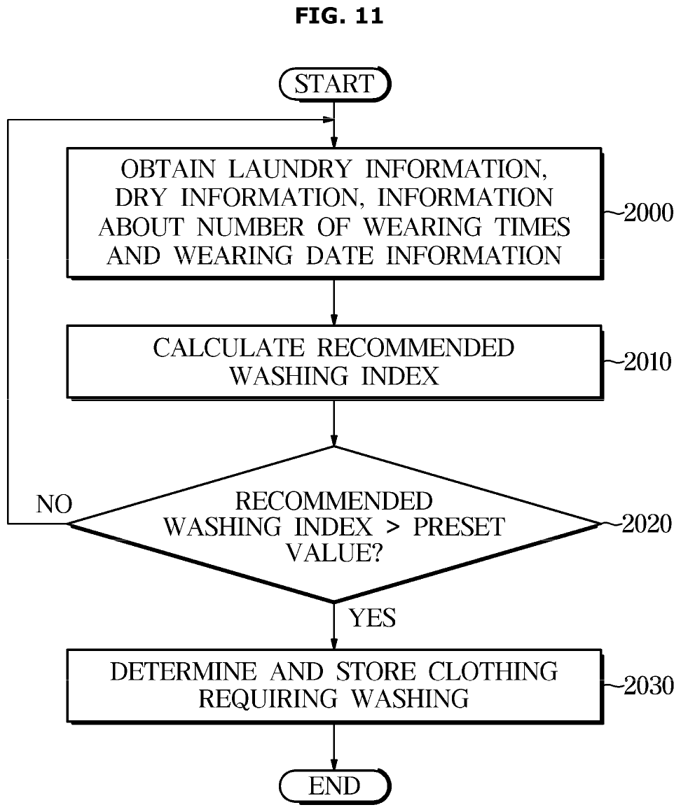

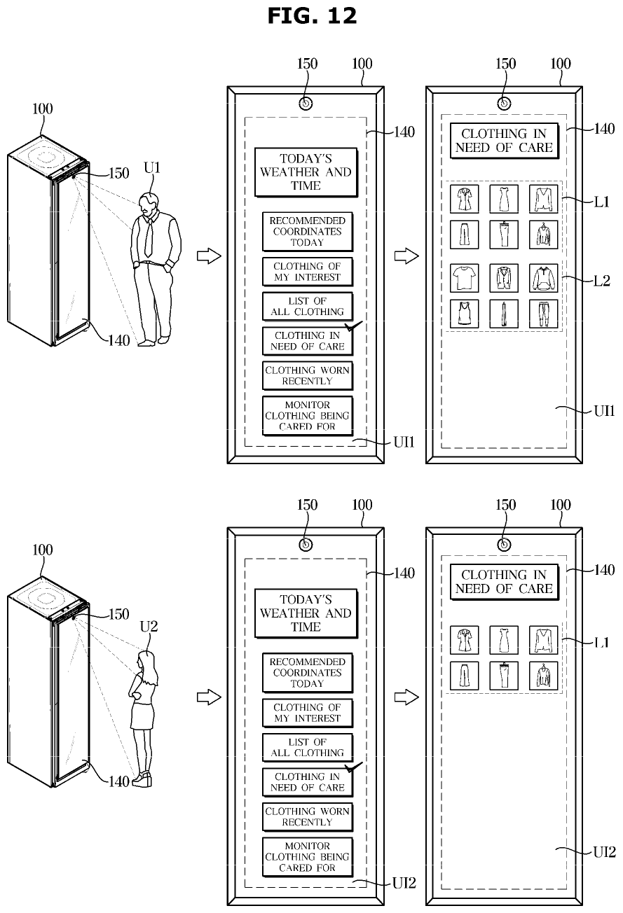

FIG. 11 is a flowchart illustrating a procedure in which a clothing treatment device determines clothes requiring care, according to an embodiment, and FIG. 12 illustrates an example of information about clothes requiring care provided for a first user and a second user.

Referring to FIG. 11, the controller 110 may obtain laundry information, information about the number of wearing times and wearing date information of clothes owned by a plurality of users from the storage 130 in 2000, and calculate a recommended washing index based on the laundry information, information about the number of wearing times and wearing date information of the clothes owned by the plurality of users in 2010.

Specifically, the controller 110 may calculate the recommended washing index by giving a weight to each item such as the number of wearing times and hours, weather of a wearing day, a laundry date, or a dry date of the clothes, determine clothes with recommended washing indexes equal to or greater than a preset value as clothes requiring washing, and store them in the storage 130, in 2030.

Afterwards, the controller 110 may control the display 140 to provide a user interface for providing information about clothes requiring washing depending on the user captured by the camera 150.

Referring to FIG. 12, the controller 110 may control the display 140 to provide information about clothes requiring washing among clothes owned by the plurality of users U1 and U2 when an object captured by the camera 150 is determined as the first user U1. Specifically, the controller 110 may provide both information L2 about clothes requiring care among the clothes owned by the first user U1 and information L1 about clothes requiring care among the clothes owned by the second user U2 in response to a user input to select a menu about clothes requiring care on the first user interface UI1.

On the other hand, when the object captured by the camera 150 is determined as the second user U2, the controller 110 may control the display 140 to provide information about clothes requiring washing among the clothes owned by the second user U2. Specifically, the controller 110 may provide the information L1 about clothes requiring care among the clothes owned by the second user U2 in response to a user input to select a menu about clothes requiring care on the second user interface UI2.

In other words, the clothing treatment device 100 may provide a list of clothes requiring washing among the clothes owned by all the family members U1 and U2 for the first user U1 and a list of clothes requiring washing among the clothes owned by the second user U2 for the second user U2, according to information about the first user U1 and second user U2 or settings input from the user U1 or U2.

In this case, the information about the first user U1 and second user U2 may include information about an occupation, sex, age, etc., of the first user U1 and second user U2.

For example, when the occupation of the first user U1 is stored as a homemaker and the occupation of the second user U2 is stored as a student, the clothing treatment device 100 may provide different information about the clothes requiring washing for each user.

In another example, when the user U1 or U2 sets the first user U1 as a user to share the laundry, the clothing treatment device 100 may provide different information about the clothes requiring washing for each user.

According to an embodiment, the clothing treatment system may help a family member efficiently take care of clothes at home by providing individualized information for each user.

Furthermore, the clothing treatment device 100 may send information about the clothes requiring washing among the clothes owned by the plurality of users to the washing machine 200 or the dryer 300 through the server 400 in response to a user input to select the menu m4 for providing information about clothes requiring care or a separate user input.

In other words, the controller 110 may control the communicator 120 to send the information about clothes requiring washing among the clothes owned by the plurality of users U1 and U2 to the washing machine 200 or the dryer 300 through the server 400.

On receiving the information about clothes requiring washing, the washing machine 200 may set a suitable laundry course in advance without a user input by comparing the information about clothes requiring washing with clothing information stored in the storage 230.

On receiving the information about clothes requiring washing, the dryer 300 may set a suitable dry course in advance without a user input by comparing the information about clothes requiring washing with clothing information stored in the storage 330.

Accordingly, the user U1 or U2 may wash clothes through the most efficient laundry course by simply operating the washing machine 200 without setting a laundry course, and dry clothes through the most efficient dry course by simply operating the dryer 300 without setting a dry course.

In an embodiment, the clothing treatment system may provide individualized clothing information for each user as well as provide information about a home appliance 200 or 300 individualized for each user.

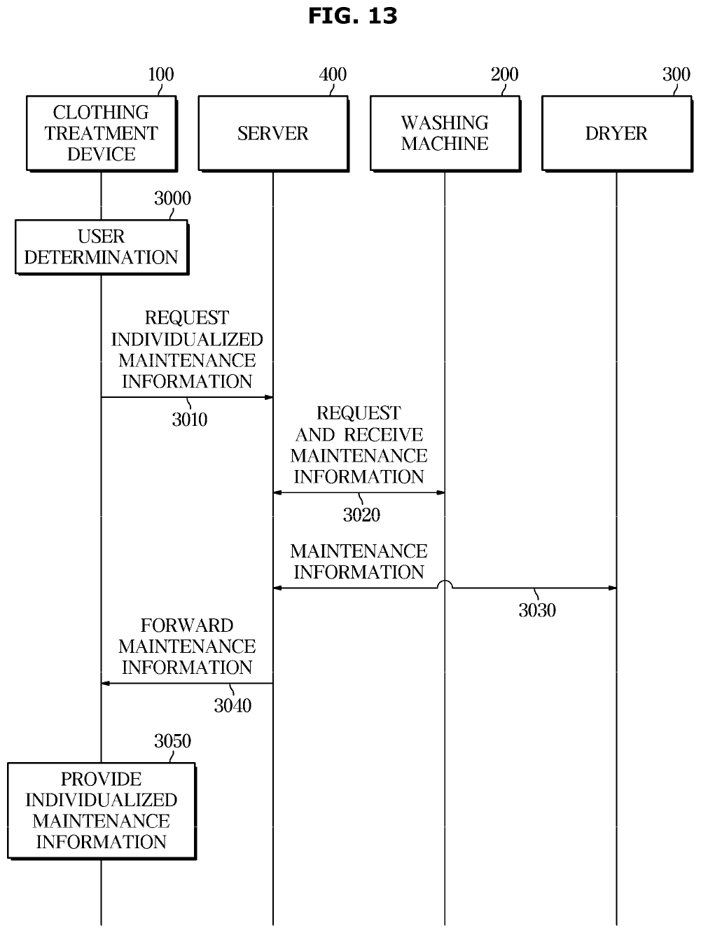

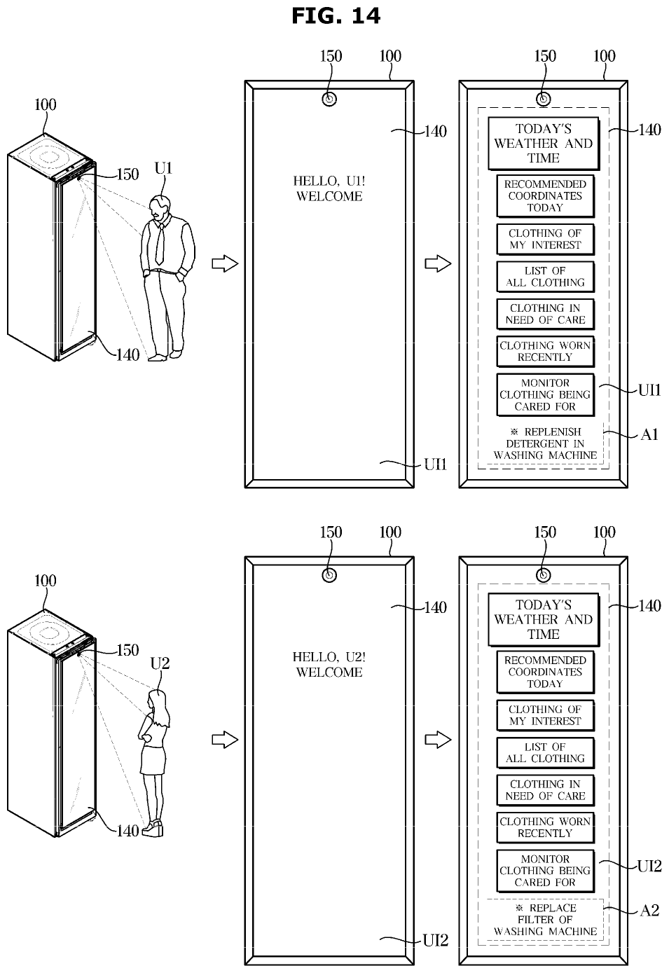

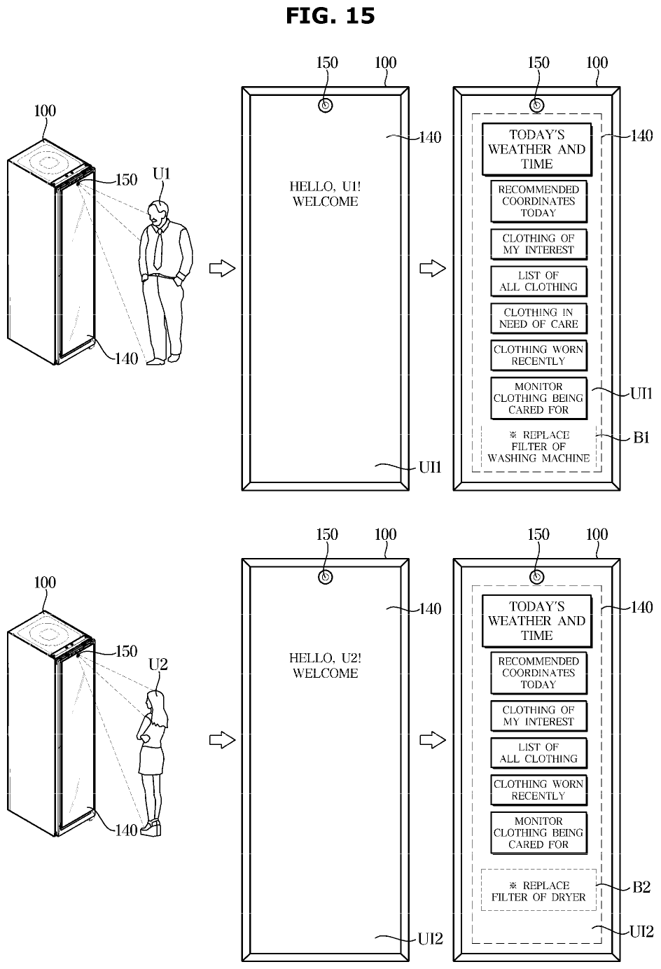

FIG. 13 is a sequence chart illustrating a procedure in which a clothing treatment system provides individualized maintenance information, according to an embodiment, FIG. 14 illustrates an example of maintenance information of a home appliance provided for a first user and a second user, and FIG. 15 illustrates another example of maintenance information of a home appliance provided for a first user and a second user.

Referring to FIG. 13, the clothing treatment device 100 may determine what user an object captured by the camera 150 is in 3000, and provide maintenance information of the home appliance depending on the user in 3050.

As described above, the maintenance information of the home appliance 200 or 300 may refer to information for maintenance of the home appliance.

The controller 210 of the washing machine 200 may control the communicator 220 to send the maintenance information of the washing machine 200 to the server 400 when determining that maintenance of the washing machine 200 is required based on data collected from the sensor module 240.

Furthermore, the controller 310 of the dryer 300 may control the communicator 220 to send the maintenance information of the dryer 300 to the server 400 when determining that maintenance of the dryer 300 is required based on data collected from the sensor module 340.

On the other hand, the washing machine 200 and/or the dryer 300 may send the maintenance information of the washing machine 200 and/or the dryer 300 to the server 400 in response to receiving a request for the maintenance information from the server 400.

The server 400 may store the maintenance information received from a home appliance such as the washing machine 200 and/or the dryer 300 in the storage 430, and send the maintenance information received from the home appliance (200 or 300) to the clothing treatment device 100.

The server 400 may send the maintenance information of the home appliance 200 or 300 to the clothing treatment device 100 in response to receiving the maintenance information from the home appliance 200 or 300, or send the maintenance information of the home appliance 200 or 300 to the clothing treatment device 100 in response to receiving a request for the maintenance information of the home appliance 200 or 300 from the clothing treatment device 100.

In other words, the clothing treatment device 100 may request individualized maintenance information from the server 400 depending on a user captured by the camera 150 in 3010, and the server 400 may request maintenance information from the home appliance 200 or 300 in response to the request for the individualized maintenance information and receive the maintenance information in 3020 and 3030.

For example, the controller 110 may control the communicator 120 to request maintenance information of a first type from the home appliance 200 or 300 through the server 400 when an object captured by the camera 150 is determined as the first user U1, and control the communicator 120 to request maintenance information of a second type from the home appliance 200 or 300 through the server 400 when an object captured by the camera 150 is determined as the second user U2.

Afterwards, the server 400 may send the maintenance information received from the home appliance 200 or 300 to the clothing treatment device 100 in 3040, and the clothing treatment device 100 may provide individualized maintenance information for the user depending on the user captured by the camera 150 in 3050.

The clothing treatment device 100 may control the display 140 to provide maintenance information of the home appliance 200 or 300 for the first user U1 when an object captured by the camera 150 is determined as the first user U1 and a maintenance type of the home appliance 200 or 300 corresponds to the first type, and control the display 140 to provide maintenance information of the home appliance 200 or 300 for the second user U2 when an object captured by the camera 150 is determined as the second user U2 and a maintenance type of the home appliance 200 or 300 corresponds to the second type.

Maintenance types may be classified and stored in advance in the storages 130, 230, 330 and 430.

For example, referring to FIG. 14, the controller 110 may control the display 140 to provide maintenance information A1 of a home appliance for the first user U1 when an object captured by the camera 150 is determined as the first user U1 and a maintenance type of the washing machine 200 corresponds to detergent replenishment, and control the display 140 to provide maintenance information A2 of the washing machine 200 for the second user U2 when an object captured by the camera 150 is determined as the second user U2 and a maintenance type of the washing machine 200 corresponds to filter replacement.

For this, the controller 110 may control the communicator 120 to request maintenance information of the first type from the home appliance 200 or 300 through the server 400 when an object captured by the camera 150 is determined as the first user U1, and control the communicator 120 to request maintenance information of the second type from the home appliance 200 or 300 through the server 400 when an object captured by the camera 150 is determined as the second user U2.

In other words, the clothing treatment device 100 may provide maintenance information requiring relatively simple maintenance for the first user U1 and maintenance information requiring relatively difficult maintenance for the second user U2, depending on the information about the first user U1 and the second user U2 or the settings input from the user.

In this case, the information about the first user U1 and second user U2 may include information about an occupation, sex, age, etc., of the first user U1 and second user U2.

For example, when the occupation of the first user U1 is stored as a homemaker and the occupation of the second user U2 is stored as a company employee, the clothing treatment device 100 may provide different maintenance information for each user as described above.

In another example, when a user sets the first user U1 as a user to share the detergent replenishment of the washing machine 200, the clothing treatment device 100 may provide maintenance information about the detergent replenishment for the first user U1, and when a user sets the second user U2 as a user to share the filter replacement of the washing machine 200, the clothing treatment device 100 may provide maintenance information about the filter replacement for the second user U2.

Furthermore, the user may set the first user U1 as a user to share maintenance of the washing machine 200 and the second user U2 as a user to share maintenance of the dryer 300.

Referring to FIG. 15, the controller 110 may control the communicator to request maintenance information from the washing machine 200 through the server 400 when an object captured by the camera 150 is determined as the first user U1, and control the communicator to request maintenance information from the dryer 300 through the server 400 when an object captured by the camera 150 is determined as the second user U2.

Accordingly, the controller 110 may control the display 140 to provide maintenance information B1 of the washing machine 200 for the first user U1 when an object captured by the camera 150 is determined as the first user U1 and maintenance information of the washing machine 200 is received, and control the display 140 to provide maintenance information B2 of the dryer 300 for the second user U2 when an object captured by the camera 150 is determined as the second user U2 and maintenance information of the dryer 300 is received.

According to an embodiment, the clothing treatment system may help a family member efficiently take care of maintenance of home appliances to care for clothes at home by providing individualized maintenance information for each user.

Meanwhile, the embodiments of the disclosure may be implemented in the form of a recording medium for storing instructions to be carried out by a computer. The instructions may be stored in the form of program codes, and when executed by a processor, may generate program modules to perform operation in the embodiments of the disclosure. The recording media may correspond to computer-readable recording media.

The computer-readable recording medium includes any type of recording medium having data stored thereon that may be thereafter read by a computer. For example, it may be a read only memory (ROM), a random access memory (RAM), a magnetic tape, a magnetic disk, a flash memory, an optical data storage device, etc.

The computer-readable storage medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the non-transitory storage medium may include a buffer that temporarily stores data.

In an embodiment of the disclosure, the aforementioned method according to the various embodiments of the disclosure may be provided in a computer program product. The computer program product may be a commercial product that may be traded between a seller and a buyer. The computer program product may be distributed in the form of a recording medium (e.g., a compact disc read only memory (CD-ROM)), through an application store (e.g., play store™) directly between two user devices (e.g., smart phones), or online (e.g., downloaded or uploaded). In the case of online distribution, at least part of the computer program product (e.g., a downloadable app) may be at least temporarily stored or arbitrarily created in a recording medium that may be readable to a device such as the server 400 of the manufacturer, the server 400 of the application store, or the relay server 400.

The embodiments of the disclosure have thus far been described with reference to accompanying drawings. It will be obvious to those of ordinary skill in the art that the disclosure may be practiced in other forms than the embodiments of the disclosure as described above without changing the technical idea or essential features of the disclosure. The above embodiments of the disclosure are only by way of example, and should not be construed in a limited sense.

What is claimed is:

1. A clothing treatment system comprising:
a clothing treatment device configured to store status information of clothes owned by a plurality of users including a first user and a second user;
a washing machine configured to send laundry information of the clothes owned by the plurality of users to a server; and
a dryer configured to send dry information of the clothes owned by the plurality of users to the server,
wherein the clothing treatment device is configured to receive, from the server, the laundry information sent by the washing machine to the server and the dry information sent by the dryer to the server, update status information of the clothes owned by the plurality of users based on the laundry information and dry information received from the server, provide a first user interface for providing status information of clothes owned by the first user through a display in response to an object captured by a camera determined as the first user, and provide a second user interface for providing status information of clothes owned by the second user through the display in response to an object captured by the camera determined as the second user.

2. The clothing treatment system of claim 1, wherein the clothing treatment device is configured to request laundry information of the clothes owned by the first user from the server and request dry information of the clothes owned by the first user from the server in response to an object captured by the camera determined as the first user.

3. The clothing treatment system of claim 1, wherein the clothing treatment device is configured to create recommended coordinates information for the first user based on status information of the clothes owned by the first user and provide the recommended coordinates information for the first user through the display in response to an object captured by the camera determined as the first user.

4. The clothing treatment system of claim 1, wherein the clothing treatment device is configured to recognize clothing worn by an object captured by the camera and update at least one of information about a date of wearing and information about a number of wearing times of the recognized clothing.

5. The clothing treatment system of claim 4, wherein the clothing treatment device is configured to determine clothing requiring washing among the clothes owned by the plurality of users based on at least one of laundry information, dry information, information about the number of wearing times, and wearing date information of the clothes owned by the plurality of users, and provide information about the clothing requiring washing among clothes owned by the first user through the display in response to an object captured by the camera determined as the first user.

6. The clothing treatment system of claim 5, wherein the clothing treatment device is configured to send information about clothes requiring washing among the clothes owned by the first user to at least one of the washing machine and the dryer through the server.

7. The clothing treatment system of claim 1, wherein the clothing treatment device is configured to update location information of the clothes owned by the plurality of users based on at least one of laundry information of the clothes owned by the plurality of users and dry information of the clothes owned by the plurality of users.

8. The clothing treatment system of claim 1, wherein
the washing machine is configured to send maintenance information of the washing machine to the clothing treatment device through the server, and
the clothing treatment device is configured to provide the maintenance information of the washing machine to the first user through the display in response to an object captured by the camera determined as the first user and a maintenance type of the washing machine corresponding to a first type, and provide the maintenance information of the washing machine to the second user through the display in response to an object captured by the camera determined as the second user and a maintenance type of the washing machine corresponding to a second type.

9. The clothing treatment system of claim 1, wherein
the dryer is configured to send maintenance information of the dryer to the clothing treatment device through the server, and
the clothing treatment device is configured to provide the maintenance information of the dryer to the first user through the display in response to an object captured by the camera determined as the first user and a maintenance type of the dryer corresponding to a first type, and provide the maintenance information of the dryer to the second user through the display in response to an object captured by the camera determined as the second user and a maintenance type of the dryer corresponding to a second type.

10. A clothing treatment device comprising:
a storage configured to store status information of clothes owned by a plurality of users including a first user and a second user;
a communicator configured to receive at least one of laundry information, dry information, and location information of the clothes owned by the plurality of users, from a server;
a camera;
a display; and
a controller configured to update the status information of the clothes owned by the plurality of users based on at least one of the laundry information, dry information, and location information of the clothes owned by the plurality of users, control the display to provide a first user interface for providing status information of clothes owned by the first user in response to an object captured by the camera determined as the first user, and control the display to provide a second user interface for providing status information of clothes owned by the second user in response to an object captured by the camera determined as the second user.

11. The clothing treatment device of claim 10, wherein the controller is configured to control the communicator to request at least one of laundry information, dry information, and location information of the clothes owned by the first user from the server in response to an object captured by the camera determined as the first user.

12. The clothing treatment device of claim 10, wherein the controller is configured to create recommended coordinates information for the first user based on the status information of the clothes owned by the first user in response to an object captured by the camera determined as the first user, and control the display to provide the recommended coordinates information for the first user.

13. The clothing treatment device of claim 10, wherein the controller is configured to recognize clothing worn by an object captured by the camera and update at least one of information about a date of wearing and information about a number of wearing times of the recognized clothing.

14. The clothing treatment device of claim 13, wherein the controller is configured to determine clothing requiring washing among the clothes owned by the plurality of users based on at least one of laundry information, dry information, information about the number of wearing times, and wearing date information of the clothes owned by the plurality of users, and control the display to provide information about the clothing requiring washing among clothes owned by the first user in response to an object captured by the camera determined as the first user.

15. The clothing treatment device of claim 13, wherein the controller is configured to determine clothing requiring washing among the clothes owned by the plurality of users based on at least one of laundry information, dry information, information about the number of wearing times, and wearing date information of the clothes owned by the plurality of users, and control the display to provide information about the clothing requiring washing among the clothes owned by the plurality of users in response to an object captured by the camera determined as the first user.
